(19) United States
(12) Patent Application Publication
(10) Pub. No.: US 2024/0364110 A1
(43) Pub. Date: Oct. 31, 2024

(54) Charging System

(71) Applicant: EGTRONICS Co., Ltd., Hwaseong-Si (KR)

(72) Inventors: Chan-Ho Kang, Hwaseong-Si (KR); Young-Gun Hong, Goyang-Si (KR); Ui-Soung Park, Daejeon (KR); Ko Choi, Seoul (KR); Su-Kang Lee, Incheon (KR)

(21) Appl. No.: 18/648,281

(22) Filed: Apr. 26, 2024

(30) Foreign Application Priority Data
Apr. 28, 2023 (KR) 10-2023-0056319

(51) Int. Cl. H02J 3/26; H02J 7/00

(52) U.S. Cl. CPC H02J 3/26; H02J 7/00714; H02J 7/007182

(57) ABSTRACT

The present disclosure relates to a charging system, and more specifically, to a charging system which can prevent power imbalance in each phase in a system that supplies power to one of three phases. The charging system according to various embodiments of the present disclosure described above, the first to third charging terminals are always connected to the R-phase, S-phase, and T-phase of the system respectively, and the fourth to k-th charging terminals are each connected to the R-phase, S-phase, and T-phase using the first to (k−3)th relays when necessary, thereby reducing the number of relays than before. Further, the control unit controls the first to (k−3)th relay units to reduce the load amount deviation in each phase according to the load amount connected to the R-phase, S-phase, and T-phase, thereby eliminating imbalance of the load amount of each phase.

### CROSS-REFERENCE TO RELATED APPLICATION(S)

This application is based on and claims priority of Korean Patent Application No. 10-2023-0056319, filed on Apr. 28, 2023 with the Korean Intellectual Property Office, the entire contents of which are hereby incorporated by reference.

### TECHNICAL FIELD

The present disclosure relates to a charging system, and more specifically, to a charging system which can prevent power imbalance in each phase in a system that supplies power to one of three phases.

### BACKGROUND

A slow charger for electric vehicles generally has an output of 6 to 7 kW and is mainly used at homes or public charging stations. Generally, when using a fast charger for an electric vehicle, full charging can be done in tens of minutes, but when using a slow charger, it takes several hours to fully charge.

FIG. 1 is a circuit diagram of an example slow charger used for charging electric vehicles.

As shown in FIG. 1, an example slow charger for an electric vehicle may include an output terminal configured by connecting any one of the R-phase, T-phase, and S-phase of the system and a neutral line, and a relay between each phase and the output terminal.

In the case of the slow charger, 3 relays for each output terminals are required. If the number of output terminals is 9, a total of 27 relays are required, which makes the configuration of the slow charger relatively complicated. Accordingly, manufacturing cost is also increased.

### SUMMARY

The present disclosure is designed to solve the technical problems described above, and the object of the present disclosure is to provide a charging system with a relatively simple structure, which is economical and has a simple operating algorithm.

Another object of the charging system according to the present disclosure is to provide a charging system capable of equalizing the load amount on each phase as much as possible in a charging system charging a load in a single phase.

The charging system according to the present disclosure for solving the aforementioned technical problems may include in the charging system charging a load in a single phase a first charging terminal wherein one end is connected to a R-phase of a system and the other end is connected to a neutral line; a second charging terminal wherein one end is connected to a S-phase of the system and the other end is connected to the neutral line; a third charging terminal therein one end is connected to a T-phase of the system and the other end is connected to the neutral line; fourth to n-th charging terminals (n is a natural number of 4 or more) wherein each of three branched ends is connected to the R-phase, S-phase, and T-phase and other ends are connected to the neutral line so that the fourth to n-th charging terminals are parallelly connected to the first to third charging terminals; first to (n−3)th relay units each comprising three relays; and a control unit controlling the first to (n−3)th relay units to reduce deviation according to load connected to the R-phase, S-phase, and T-phase, wherein one ends of each of the three relays are connected to each of branched three one ends of each of the fourth to n-th charging terminals, and each of other ends are connected to the R-phase, S-phase, and T-phase of the system.

Further, the charging system further includes first to n-th current sensors installed on sides of the first to the n-th charging terminals, sensing current flowing to each charging terminal.

Further, the control unit calculates load amount of each phase according to information of phases to which each of the charging terminals are connected according to operation of the fourth to n-th relay units and current values sensed from the first to n-th current sensors, and controls the first to (n−3)th relay units to reduce the load amount deviation of each phase.

Further, the control unit compares a voltage of a first phase which is connected to the k-th charging terminal and one of the R-phase, S-phase, and T-phase to a voltage of a second phase which is one of remaining phases when changing a phase connected to the k-th charging terminal from the first phase to the second phase, wherein the control unit controls a relay of the (k−3)th relay unit to change the phase connected to the k-th charging terminal to the second phase when the voltage of the first phase and the second phase becomes equal.

Further, the control unit considers a delay in which a control signal is applied to the (k−3)th relay unit and applies the control signal to the (k−3)th relay unit a predetermined time before a time when voltages of the first phase and the second phase become equal.

Further, the (k−3)th relay unit comprises a first relay which is turned ON or OFF to connect the k-th charging terminal to the first phase, and a second relay which is turned ON or OFF to connect the k-th charging terminal to the second phase, and the control unit 10, assuming that a time when voltages of the first phase and the second phase become equal to each other is t0, applies a first control signal to the first relay a predetermined time before t0, and applies a control signal to the second relay at a time point between application of the first control signal and the t0.

Further, the control unit controls a relay unit of a charging terminal which is not charging or has completed charging among the first to (k−3)th relay units to prevent the corresponding charging terminal from being connected to the system.

The charging system according to various embodiments of the present disclosure described above, the first to third charging terminals are always connected to the R-phase, S-phase, and T-phase of the system respectively, and the fourth to k-th charging terminals are each connected to the R-phase, S-phase, and T-phase using the first to (k−3)th relays when necessary, thereby reducing the number of relays than before. Further, the control unit controls the first to (k−3)th relay units to reduce the load amount deviation in each phase according to the load amount connected to the R-phase, S-phase, and T-phase, thereby eliminating imbalance of the load amount of each phase.

### BRIEF DESCRIPTION OF DRAWINGS

FIG. 1 is a circuit diagram of an example slow charger used for charging electric vehicles.

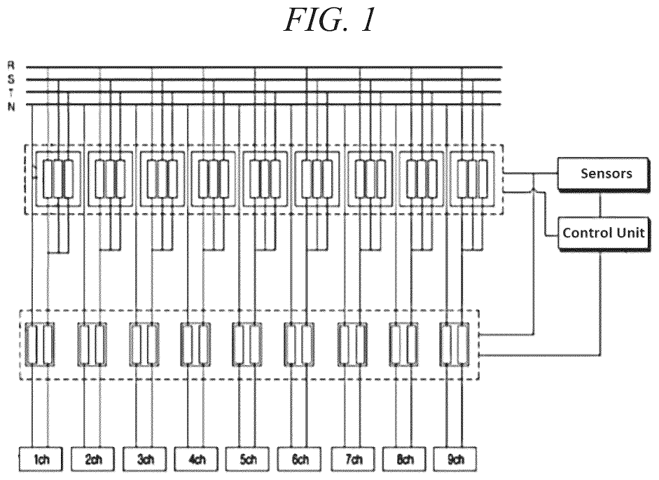

FIG. 2 is a circuit diagram of a charging system according to an embodiment of the present disclosure.

### DETAILED DESCRIPTION OF EXEMPLARY EMBODIMENTS

The object, features, and advantages of the present disclosure will become more apparent with the following embodiments related to the attached drawings. The following specific structural or functional descriptions are exemplified for the purpose of illustrating embodiments in accordance with the concepts of the present disclosure only, and embodiments in accordance with the concepts of the present disclosure may be implemented in various forms and should not be construed as limiting to the embodiments described herein or in the application.

Since the embodiments according to the concepts of the present disclosure are subject to various modifications and may take many forms, certain embodiments are to be illustrated in the drawings and described in detail in the present specification or application. However, this is not intended to limit the embodiments according to the concepts of the present disclosure to any particular disclosed form, and is to be understood to include all modifications, equivalents, or substitutions that fall within the scope of the ideas and techniques of the present disclosure.

Terms such as first and/or second may be used to describe various components, but the components are not limited to the terms. The above terms are used solely for the purpose of distinguishing one component from another, e.g. a first component may be named a second component, and similarly a second component may be named a first component, without departing from the scope of the rights in accordance with the concept of the disclosure.

When a component is referred to as coupled to or connected to another component, it should be understood that it may be directly coupled to or connected to that other component, but there may be other components in between. On the other hand, when a component is said to be directly coupled to or connected to another component, it should be understood that there is no other component in between.

Other expressions to describe the relationship between components, such as between ˜ and directly between ˜ or adjacent to ˜ and directly adjacent to ˜, should be interpreted similarly. The terms used herein is intended to describe particular embodiments only and is not intended to limit the present disclosure.

Singular expressions include plural expressions unless context clearly indicates otherwise. Terms used in the present disclosure such as include or comprise are intended to designate the presence of the features, numbers, steps, operations, components, parts, or combinations thereof described, and are not intended to preclude the presence or addition of one or more other features, numbers, steps, operations, components, parts, or combinations thereof.

Unless otherwise defined, all terms used herein, including technical or scientific terms, have the same meaning as commonly understood by a person of ordinary skill in the technical field to which the disclosure belongs. Terms such as those defined in commonly used dictionaries shall be construed to have meanings consistent with their meaning in the context of the relevant art and shall not be construed to have an idealized or unduly formal meaning unless expressly defined in this specification.

Hereinafter, the present disclosure will be described in detail by describing the preferred embodiments of the present disclosure with reference to the attached drawings. The same reference numerals shown in each drawing refer to the same elements.

A charging system according to one embodiment of the present disclosure is a charging system charging a load in a single phase. At this time, the load may generally be an electric vehicle (or a plug-in hybrid vehicle), but the present disclosure does not limit the load to an electric vehicle, and the load may be various types of electronic devices.

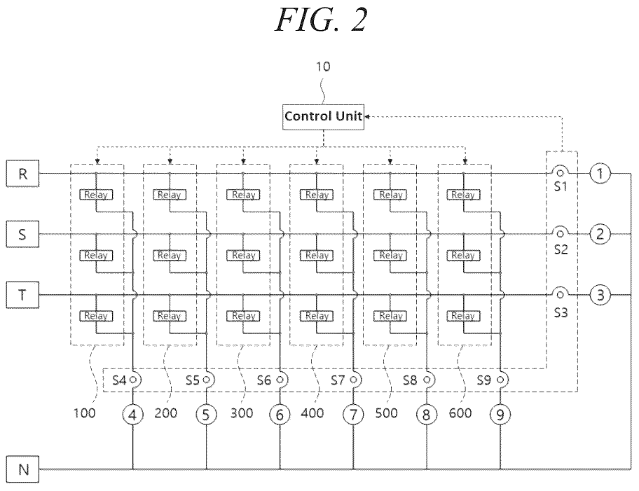

FIG. 2 is a circuit diagram of a charging system according to one embodiment of the present disclosure.

As shown in FIG. 2, the charging system according to one embodiment of the present disclosure is a charging system connected to a system, and may include first to ninth charging terminals 1, 2, 3, 4, 5, 6, 7, 8, and 9, first to sixth relay units 100, 200, 300, 400, 500, and 600, first to ninth current sensors S1, S2, S3, S4, S5, S6, S7, S8, and S9, and a control unit 10.

Among the first to ninth charging terminals 1, 2, 3, 4, 5, 6, 7, 8, and 9, one ends of the first to third charging terminals 1, 2, and 3 are connected to R-phase, S-phase, and T-phase of the system, and the other ends are connected to a neutral line. The first to third charging terminals 1, 2, and 3 are charging terminals in which separate relays are not installed, and the fourth to ninth charging terminals 4, 5, 6, 7, 8, and 9 are charging terminal in which individual relays are installed.

The fourth to ninth charging terminals 4, 5, 6, 7, 8, and 9 are connected to the R-phase, S-phase, and T-phase of the system through three individually branched one ends. The other ends are connected to the neutral line. In the charging system according to the present disclosure, the first to third charging terminals 1, 2, and 3 are essential, and the total number of the fourth to ninth charging terminals 4, 5, 6, 7, 8, and 9 is six. In this case, the number of remaining charging terminals except for the first to third charging terminals 1, 2, and 3 may be at least one or more, and is not limited to six as the charging system according to the present disclosure.

The load may be connected to any one of the first to ninth charging terminals 1, 2, 3, 4, 5, 6, 7, 8, and 9 to charge the battery. The load may be an electric vehicle as described above, wherein the electric vehicle is connected between any one of the R-phase, S-phase, and T-phase and the neutral line (N) to charge a battery included in the electric vehicle in a single-phase.

First to sixth relay units 100, 200, 300, 400, 500, and 600 are installed on the fourth to ninth charging terminals 4, 5, 6, 7, 8, and 9, respectively. More specifically, each of the first to sixth relay units 100, 200, 300, 400, 500, and 600 includes three relays, each of which serves to connect a single charging terminal to the R-phase, S-phase, and T-phase. According to the embodiment of the present disclosure, only one of the three relays included in a single relay unit is connected to the R-phase, S-phase, and T-phase. This is because if two or more relays are connected to multiple phases of R-phase, S-phase, and T-phase, they may be shorted due to voltage differences between the phases, causing damage to the system and the electric vehicle connected to the charging terminal.

For the conventional slow charger described earlier, the number of charging terminals is nine, which is the same as in the present embodiment. However, a total of twenty-seven relays are required for the conventional slow charger, since relays should be provided for each charging terminal. In contrast, the present embodiment is equipped with relays for a total of six charging terminals of the fourth to ninth charging terminals 4, 5, 6, 7, 8, and 9, so a total of eighteen relays are required, three for each charging terminal. That is, the present embodiment has the effect of simplifying the system itself by using fewer relays than the prior art, which can improve economic efficiency, and simplify the operation algorithm itself using the relays.

First to ninth current sensors S1, S2, S3, S4, S5, S6, S7, S8, and S9 are installed on each side of the first to ninth charging terminals 1, 2, 3, 4, 5, 6, 7, 8, and 9 to sense the flow of current. The first to ninth current sensors S1, S2, S3, S4, S5, S6, S7, S8, and S9 may be general sensors using Hall effect. However, the present disclosure does not limit the first to ninth current sensors S1, S2, S3, S4, S5, S6, S7, S8, and S9 to a method utilizing the Hall effect, and current sensors such as sandwich sensors, branch type sensors, temperature compensation current sensors, and the like may be used.

A control unit 10 controls the first to sixth relay units 100, 200, 300, 400, 500, and 600 to reduce the load deviation of each phase according to the load amount connected to the R-phase, S-phase, and T-phase. More specifically, the control unit 10 senses operating status of the first to sixth relay units 100, 200, 300, 400, 500, and 600, and the load amount of each of the R-phase, S-phase, and T-phase according to the current value sensed in each of the first to ninth current sensors S1, S2, S3, S4, S5, S6, S7, S8, and S9. Then, the control unit 10 controls the operation of the first to sixth relay units 100, 200, 300, 400, 500, and 600 so that the deviation of the load amount of each phase is reduced. For example, when an electric vehicle is being charged in each of the first to third charging terminals 1, 2, and 3, and an electric vehicle is connected to the fourth charging terminal 4 for charging, the control unit 10 may control the relay included in the first relay unit 100 so that the fourth charging terminal 4 connects to the R-phase. Afterwards, when the electric vehicle charging in the 2nd charging terminal 2 completes charging and disconnects, two electric vehicles are charging in the R-phase, one electric vehicle is charging in the T-phase, and there is no load amount in the S-phase, thereby increasing the load amount deviation in each phase. Therefore, the control unit 10 may control the relay included in the first relay unit 100, which is the relay unit of the fourth charging terminal 4 connected to the R-phase, and change the phase to which the fourth charging terminal 4 is connected from R-phase to the S-phase, thereby reducing the load amount deviation of each phase.

The control unit 10 may detect the load amount in each of the R-phase, S-phase, and T-phase with the sensing amount of each the first to ninth current sensors S1, S2, S3, S4, S5, S6, S7, S8, and S9, connection of electric vehicles to each of the first to third charging terminals 1, 2, and 3, and the operation of the first to sixth relay units 100, 200, 300, 400, 500, and 600.

For the operation described above, the control unit 10 may be connected wired or wirelessly to the first to ninth current sensors S1, S2, S3, S4, S5, S6, S7, S8, and S9 to receive the sensing amount, and may be connected wired or wirelessly to the first to sixth relay units 100, 200, 300, 400, 500, and 600 to apply control signals to the first to sixth relay units 100, 200, 300, 400, 500, and 600. The control unit 10 may be implemented as an electronic element or an electronic device including an electronic element that can perform operations such as signal transmission/reception/computation.

As explained previously, to change the phase to which the fourth charging terminal 4 is connected from the R-phase to the S-phase, the control unit 10 should turn OFF the first relay connecting the fourth charging terminal 4 and the R-phase among the relays included in the first relay unit 100, and turn ON the second relay connecting the fourth charging terminal 4 and the S-phase. If the voltage difference between the R-phase and the S-phase is large at the transition time when the first relay is OFF and the second relay is ON, damage may be caused to the relay and the electric vehicle connected to the fourth charging terminal 4. In this embodiment, in order to solve the technical problem described above, the voltage of the R-phase to which the fourth charging terminal 4 is connected, and the S-phase which is the phase to be changed, are compared with each other. When the voltage difference between each phase becomes zero, the first relay is turned from ON to OFF and the second relay is turned from OFF to ON.

In this case, if the first relay is turned OFF before the second relay is turned ON, both the first and second relays are turned OFF, resulting in a period where power is not charged, reducing power charging efficiency. If the second relay is turned ON before the first relay is turned OFF, the R-phase and the S-phase are shorted to each other, causing current to flow, which may cause malfunction and failure. Therefore, ideally, it is desirable for the first relay and the second relay to be turned ON/OFF at the same time.

Ideally, if the control unit 10 applies a control signal to the first relay and the second relay when the voltage difference between the R-phase and S-phases becomes zero, the first relay and the second relay may be turned ON/OFF at the moment the voltage difference between the R-phase and the S-phase becomes zero to change the phase to which the fourth charging terminal 4 is connected. However substantially, the length of the line between the control unit 10 and the relay, the structure of the device that constitutes the control unit 10, and various other factors determine the timing of applying the control signal from the control unit 10, and the operation times of the first relay and the second relays may be different. Therefore, the control unit 10 may calculate when the voltages on the R-phase and the S-phase are mutually zeroed, and transmit control signals to each of the first relay and the second relay while considering the delay of the control signals. If the signal applied to the first relay to change the state of the first relay from ON to OFF is called the first control signal, and the signal applied to the second relay to change the state of the second relay from OFF to ON is called the second control signal, the control unit 10 may transmit the first control signal before the second control signal and transmit the second control signal later than the first control signal in consideration of the delay time. If the time point of applying the first control signal is called t1_cmd, the time point of applying the second control signal is called t2_cmd, and the time point when the voltages of the R-phase and the S-phases become equal is called t0, based on the time point, t1_cmd<t2_cmd<t0. If the time difference between t0 and t1_cmd is dt, t2_cmd=t1_cmd+dt/2. As such, applying the first control signal earlier than the second control signal (i.e., the state of the first relay is changed from ON to OFF before the state of the second relay), as in the present embodiment, is beneficial to the safety of the system and the electric vehicle that is the load, even if the states of the first and second relays do not exactly convert to ON/OFF at time to due to error or noise, than if the state of the second relay is changed from OFF to ON before the state of the first relay, resulting in a short circuit.

For the charging terminal used to charge the load among the fourth to ninth charging terminals 4, 5, 6, 7, 8, and 9, when charging of the load is completed, the relay unit connected to the charging terminal may be controlled so that the charging terminal is not connected to any of the R-phase, S-phase, and T-phase. This is to prevent overcharging when an electric vehicle is connected to the charging terminal, and to prevent noise when a fully charged electric vehicle disconnects from the charging terminal, or when a new electric vehicle connects to the charging terminal. The control unit 10 controlling the relay unit to disconnect the connection between the charging terminal and the system may be done through sensing the voltage on the phase connected to the charging terminal and disconnecting the connection between the charging terminal and the system when the voltage is zero. This is to prevent damage to the relay and the load. In the above process, the control unit 10 may also transmit the control signal to the relay part considering the delay of the control signal.

The following is a list of embodiments of the present disclosure.

Item 1 is a charging system comprising a first charging terminal wherein one end is connected to a R-phase of a system and the other end is connected to a neutral line; a second charging terminal wherein one end is connected to a S-phase of the system and the other end is connected to the neutral line; a third charging terminal therein one end is connected to a T-phase of the system and the other end is connected to the neutral line; fourth to n-th charging terminals (n is a natural number of 4 or more) wherein each of three branched ends is connected to the R-phase, S-phase, and T-phase and other ends are connected to the neutral line so that the fourth to n-th charging terminals are parallelly connected to the first to third charging terminals; first to (n−3)th relay units each comprising three relays; and a control unit controlling the first to (n−3)th relay units to reduce deviation according to load connected to the R-phase, S-phase, and T-phase, wherein one ends of each of the three relays are connected to each of branched three one ends of each of the fourth to n-th charging terminals, and each of other ends are connected to the R-phase, S-phase, and T-phase of the system.

Item 2 is the charging system of item 1 comprising first to n-th current sensors installed on sides of the first to the n-th charging terminals, sensing current flowing to each charging terminal.

Item 3 is the charging system of items 1 to 2, wherein the control unit calculates load amount of each phase according to information of phases to which each of the charging terminals are connected according to operation of the fourth to n-th relay units and current values sensed from the first to n-th current sensors, and controls the first to (n−3)th relay units to reduce the load amount deviation of each phase.

Item 4 is the charging system of items 1 to 3, wherein the control unit compares a voltage of a first phase which is connected to the k-th charging terminal and one of the R-phase, S-phase, and T-phase to a voltage of a second phase which is one of remaining phases when changing a phase connected to the k-th charging terminal from the first phase to the second phase, wherein the control unit controls a relay of the (k−3)th relay unit to change the phase connected to the k-th charging terminal to the second phase when the voltage of the first phase and the second phase becomes equal.

Item 5 is the charging system of items 1 to 5, wherein the control unit considers a delay in which a control signal is applied to the (k−3)th relay unit and applies the control signal to the (k−3)th relay unit a predetermined time before a time when voltages of the first phase and the second phase become equal.

Item 6 is the charging system of items 1 to 5, wherein the (k−3)th relay unit comprises a first relay which is turned ON or OFF to connect the k-th charging terminal to the first phase, and a second relay which is turned ON or OFF to connect the k-th charging terminal to the second phase, and the control unit, assuming that a time when voltages of the first phase and the second phase become equal to each other is to, applies a first control signal to the first relay a predetermined time before t0, and applies a control signal to the second relay at a time point between application of the first control signal and the t0.

Item 7 is the charging system of items 1 to 6, wherein the control unit controls a relay unit of a charging terminal which is not charging or has completed charging among the first to (k−3)th relay units to prevent the corresponding charging terminal from being connected to the system (k is a natural number of 4 or more).

While preferred embodiments of the present disclosure have been described above, the embodiments disclosed herein are intended to illustrate and not to limit the technical ideas of the present disclosure. Therefore, the technical idea of the present disclosure includes not only each disclosed embodiment, but also a combination of the disclosed embodiments, and furthermore, the scope of the technical idea of the present disclosure is not limited by these embodiments. Further, those skilled in the art to which the present disclosure belongs may make many changes and modifications to the disclosure without departing from the spirit and scope of the appended claims, and all such appropriate changes and modifications should be considered as equivalents and as falling within the scope of the invention.

What is claimed is:

1. A charging system comprising
a first charging terminal, wherein one end of the first charging terminal is connected to a R-phase of a system and the other end of the first charging terminal is connected to a neutral line;
a second charging terminal, wherein one end of the second charging terminal is connected to a S-phase of the system and the other end of the second charging terminal is connected to the neutral line;
a third charging terminal, wherein one end of the third charging terminal is connected to a T-phase of the system and the other end of the third charging terminal is connected to the neutral line;
fourth to n-th charging terminals, wherein each of three branched ends of each of the fourth to n-th charging terminals is connected to the R-phase, S-phase, and T-phase, respectively, and other ends of each of the fourth to n-th charging terminals are connected to the neutral line so that the fourth to n-th charging terminals are parallelly connected to the first to third charging terminals, where n is a natural number greater than or equal to four;
first to (n−3)th relay units each comprising three relays; and
a controller configured to control the first to (n−3)th relay units to reduce deviation according to load connected to the R-phase, S-phase, and T-phase,
wherein first ends of each of the three relays are connected to one of three branched ends of each of the fourth to n-th charging terminals, and second ends of each of the three relays are connected to the R-phase, S-phase, and T-phase of the system, respectively.

2. The charging system of claim 1, further comprising first to n-th current sensors installed on sides of the first to the n-th charging terminals, wherein the first to n-th current sensors are configured sense current flowing to a respective charging terminal.

3. The charging system of claim 2,
wherein the controller is configured to:
determine a load amount of each phase according to information of phases to which each of the charging terminals is connected according to operation of the fourth to n-th relay units and current values sensed from the first to n-th current sensors, and
control the first to (n−3)th relay units to reduce the load amount deviation of each phase.

4. The charging system of claim 1, wherein the controller is configured to compare a voltage of a first phase which is connected to the k-th charging terminal and one of the R-phase, S-phase, and T-phase to a voltage of a second phase which is one of remaining phases when changing a phase connected to the k-th charging terminal from the first phase to the second phase, and
wherein the controller is configured to control a relay of the (k−3)th relay unit to change the phase connected to the k-th charging terminal to the second phase when the voltage of the first phase and the second phase becomes equal, where k is a natural number greater than or equal to four and less than or equal to n.

5. The charging system of claim 4, wherein the controller is configured to determine a delay in which a control signal is applied to the (k−3)th relay unit and apply the control signal to the (k−3)th relay unit a predetermined time before a time when voltages of the first phase and the second phase become equal.

6. The charging system of claim 5, wherein the (k−3)th relay unit comprises a first relay which is turned ON or OFF to connect the k-th charging terminal to the first phase, and a second relay which is turned ON or OFF to connect the k-th charging terminal to the second phase, and
wherein the controller, based on a time when voltages of the first phase and the second phase becoming equal to each other is t0, is configured to apply a first control signal to the first relay a predetermined time before t0, and apply a control signal to the second relay at a time point between application of the first control signal and the t0.

7. The charging system of claim 1, wherein the controller is configured to control a relay unit of a charging terminal which is not charging or has completed charging among the first to (k−3)th relay units to prevent the corresponding charging terminal from being connected to the system, where k is a natural number greater than or equal to four and less than or equal to n.
